(19) United States
(12) Patent Application Publication
(10) Pub. No.: US 2016/0331000 A1
(43) Pub. Date: Nov. 17, 2016

(54) DENATURED GLUCOMANNAN

(71) Applicants: TAKASHI SAWAMURA, TOKYO (JP); SUPER FREC USA, INC., GARDENA, CA (US)

(72) Inventor: TAKASHI SAWAMURA, TOKYO (JP)

(21) Appl. No.: 15/151,283

(22) Filed: May 10, 2016

(30) Foreign Application Priority Data
May 12, 2015 (JP) 2015107936

(51) Int. Cl. A23L 1/28; C08B 37/00

(52) U.S. Cl. CPC A23L 1/3002; A23L 1/3082; C08B 37/0087; A23V 2002/00

(57) ABSTRACT

According to the present invention, a low-calorie healthy food product rich in dietary fiber can be provided by using denatured glucomannan in producing food products, or by using denatured glucomannan to form a heat irreversible gelatinized food product, under a wide range of alkaline or acidic conditions. The present invention is a denatured glucomannan formed by isolating and the acetyl group of konjac-glucomannan by an alkali process to suppress swelling, whereupon the denatured glucomannan may then adjusted to be gelled or heated and gelled after being swollen by removing the swelling suppression using a high pH ingredient. Both the denatured glucomannan in addition to any gelatinized product or other food product formed from the denatured glucomannan may be dehydrated, frozen, or dried.

### CROSS-REFERENCE TO RELATED APPLICATIONS

The present application claims priority to Japanese Patent Application Serial No. JP2015-107936 filed on May 12, 2015.

### STATEMENT RE: FEDERALLY SPONSORED RESEARCH/DEVELOPMENT

Not Applicable

### BACKGROUND

1. Technical Field

The present invention relates to a denatured glucomannan product that can produce a heat irreversible gelatin easily under a wide range of pH conditions from acidity to alkalinity, and a gelatinized food product using produced using this denatured glucomannan product.

2. Background

The typical source of glucomannan for use in a food product is konjac. Konjac is a traditional food product and food product material commonly known since the ancient times in Japan, and is prized for its low caloric content, abundant dietary fiber, and unique texture. However, konjac-derived glucomannan contains certain impurities, including trimethylamine, calcium oxalate and polyphenol derivatives, and the strong konjac smell and harsh and astringent taste it gives off under alkali conditions makes it unpopular among some customers, resulting in an industry-wide problem associated with a decrease in demand. It has long been known that one way to solve this problem is via a method to neutralize and acidify the konjac-derived glucomannan.

The prior art describes a method \textcircled{1} for producing konjac-derived glucomannan under alkali or acidic conditions by using refined konjac powder which was heat-processed in an alkaline solution under conditions that suppress the swelling of konjac powder (Patent Document 1). In addition, the prior art also describes a method \textcircled{2} without using alkali conditions by deacetylating the konjac using a deacetylase (Patent Document 2).
Patent Document 1: Japanese Laid-Open Patent Application No. 2011-72304
Patent Document 2: Japanese Laid-Open Patent Application No. 2002-78457

### BRIEF SUMMARY

But in the case of method\textcircled{1}, the cost in producing an improved glucomannan is greatly increased, and suitable pH conditions under which a gelatin may be produced from the improved glucomannan is narrow, with a pH range for proper gelatinization of 7.1 to 10, resulting in production of a gelatinized product having a pH of 6.84 to 8.47. The narrow gelatinization range of method \textcircled{1} thus requires a gelatinization agent if the glucomannan is strongly acidic, which is a distinction from the present invention. In the case of method \textcircled{2}, the production process takes a long time because the production process is complicated, and the production cost is likewise greatly increased, which are additional defects. Furthermore, the process of method \textcircled{2} requires the use of deacetylase for deacetylation, which is a distinction from the present invention. Therefore, there is a need in the art for a manufacturing method that can preferably facilitate production of a gelatinized glucomannan product under a wide range of alkali to acidic conditions, and the addition and seasoning of variegated food product materials thereto, without necessitating large changes in the manufacturing facility.

Therefore, the present invention aims to provide a denatured glucomannan product that can produce a heat irreversible gelatinized food product easily under a wide pH range, from acidity to alkalinity, and a gelatinized food product produced using this denatured glucomannan product.

As a result of extensive research to solve the above described problem, it has become a well-known fact that under a certain condition where konjak-glucomannan, which normally swells in a an alkali solution, is mixed in a high pH alkali solution, it will become denatured under certain conditions and the swelling will be suppressed, with the glucomannan becoming insoluble. Further, it was found for the first time that this swelling restraint is removable under certain conditions, where the insoluble denaturated glucomannan may again become soluble and swell again. As was discovered further, this denatured glucomannan can produce a heat irreversible gelatinized food product easily under a wide range of pH conditions, from acidity to alkalinity. The present invention, the denatured glucomannan, is formed by isolating the acetyl group of konjac-glucomannan by the high alkalinity process, resulting in suppression of swelling. After neutralizing the denatured glucomannan, the swelling suppressing is removed, and it may then be gelatinized or otherwise added to a food product. The denatured glucomannan may also be dehydrated, frozen or dried, and may still be used to form a gelatinized food product.

According to the present invention, a low-calorie healthy food product rich in dietary fiber can be provided by using this denatured glucomannan and producing a heat irreversible gelatinized food product easily under a wide range of alkaline or acidic conditions.

(Producing denatured glucomannan) The denatured glucomannan of the present invention can be obtained by treating konjac-glucomannan with high alkali solution. One can judge from the outside appearance that the swelling has been suppressed by mixing the high alkali solution with konjac-glucomannan for 5-20 minutes. To confirm that the acetyl group is isolated, additional food ingredients may be added to the settled denatured glucomannan to neutralize the glucomannan, as neutralized glucomannan will have the swelling suppression removed, and if heated after swelling, will coagulate into a heat-irreversible gelatin.

The konjac-glucomannan used may be, for example, one or more of grinded konjac corm, konjak powder, or konjac-glucomannan that has been purified via washing of konjac powder with an alcohol aqueous solution. The konjac-glucomannan used does not need to be specific, and any kind may be used as long as it derives from a konjac of araceae which contains konjac-glucomannan. The ratio of konjac-glucomannan and high-alkali solution should preferably be between 1-50 parts of water for one part of the konjac-glucomannan. The water temperature should preferably be from 10 to 50° C. Calcium hydroxide, calcinated shell calcium, and eggshell calcium are desirable alkali additives. The amount of Alkali additive required is such that acetyl group of the konjac-glucomannan will become isolated, so that swelling can be suppressed. This amount is larger than alkaline amount used in typical methods of konjac-glucomannan product. Specifically, more than 7.6% of the konjac-glucomannan's weight is desirable in the case of calcium hydroxide. A pH level of 11.7 or more of alkaline solution is desirable. When the pH is too low, that swelling cannot be suppressed, and when the pH is too high, depending on the kind of and the degree of refinement of the konjac-glucomannan, swelling suppression cannot be removed sometimes.

Moreover, as a different method to obtain a denatured glucomannan, a denatured glucomamannan can be obtained by uniformly dispersing konjac-glucomannan in alkaline water and separating the acetyl group and controlling the swelling of acetyl group. To achieve the alkali conditions for performing this method, it is preferable to use an amount by weight of calcium hydroxide greater than 10% of the konjac-glucomannan' s weight, and it is preferable to use an amount by weight of alkaline water of about the same amount as the weight of the konjac-glucomannan.

(Dehydrating, freezing and drying of denatured glucomannan) Denatured glucomannan in which the acetyl group has been isolated, and in which swelling is suppressed, can be preserved by dehydrating, freezing, and/or drying denatured glucomannan, and can be used later. As to dehydration, the product can be dehydrated by ambient dehydration of moisture-containing denatured glucomannan, or the product can be dehydrated via centrifugation. Freezing of denatured glucomannan may be accomplished by refrigeration. In case of drying, it should be appreciated that dentaured glucomannan should be dried at lower temperature, because quality may degrades at higher temperature. In any case, however, denatured glucomannan is suitable for preservation due to its strong alkalinity.

(Producing Heat-Irreversible Gelatinized Product and Food Product Using Denatured Glucomannan)

By adding a pH-lowering ingredient to the alkaline solution formed by mixing water with the denatured glucomannon in which acetyl group of the konjac-glucomannon has been isolated to control swelling, the swelling suppression is removed, then after swelling, the resultant food product is obtained by gelatinizing or heating. The ingredient used is preferably a substance which reduces the pH of the denatured glucomannan solution so as to removes swelling suppression, resulting in a neutralized glucomannan. After swelling suppression is removed via addition of the pH-lowering ingredient, the neutralized glucomannan will be swollen in 2-20 minutes when stirred. It may then be heated, either packaged or placed into a container. In addition, gelatinized glucomannan, being heat-irreversible, may be put in boiling water and molded. The required time for swelling before heating for gelatinization is preferably 10-18 minutes, the heating temperature is preferably 80-90° C. (176-194° F.), and the heating time is preferably 10-60 minutes.

When the neutralized glucomannan concentration is high, it may sometimes become gelatinized without heating. When the neutralized glucomannan is formed from less than 30 parts of water to one part of denatured glucomannan, a rubber-like hard gel may sometimes obtained without heating, depending on other conditions.

The preservation method may be determined in reference with the pH. It may be sterilized in a retort vessel or frozen conditions under more neutral conditions, while boiling water sterilization is more preferable for strong acidic or and strong alkali conditions.

(Producing heat-irreversible gelatinized product and food product using denatured glucomannan which was dehydrated, frozen and dried) These may be obtained as follows: The dehydrated, frozen or dried denatured glucomannan is mixed with water ratio of 10-50 parts water to one part denatured glucomannan, and swelling suppression is removed via addition of pH-lowering ingredient while stirring for 2-20 minutes. After producing swelling, the swollen neutralized glucomannan may be gelatinized or heated. The pH-lowering ingredient that is used may be a substance free from swelling suppression, and preferably is a food product. After adding the pH-lowering ingredient, the neutralized glucomannan should be swollen in 2-20 minutes when stirred. It may then be heated, either packaged or placed into a container. In addition, gelatinized glucomannan, being heat-irreversible, may be put in boiling water and molded. The required time for swelling before heating for gelatinization is preferably 10-18 minutes, the heating temperature is preferably 80-90° C. (176-194° F.), and the heating time is preferably 10-60 minutes.

When the neutralized glucomannan concentration is high, it may sometimes become gelatinized without heating. When the neutralized glucomannan is formed from less than 30 parts of water to one part of denatured glucomannan, a rubber-like hard gel may sometimes obtained without heating, depending on other conditions.

The preservation method may be determined in reference with the pH. It may be sterilized in a retort vessel or frozen conditions under more neutral conditions, while boiling water sterilization is more preferable for strong acidic or and strong alkali conditions.

Next, certain embodiments of the denatured glucomannan according to the present invention is explained, but the present invention is not limited to these embodiments.

### EMBODIMENT 1

(Producing denatured glucomannan) Into a mixed solution in which 100 g of water and required amount of calcium hydroxide is added is added 2.5 g of konjac-glucomannan obtained from the Japanese company KONJAC, and stirred for 11 minutes. The denatured glucomannan, in which the acetyl group is isolated and swelling is suppressed, settles in the solution and is obtained.

TABLE 1
Experiment on the influence of calcium hydroxide upon Japanese
konjac-glucomannan obtained from the company KONJAC:

| | | | Konjac- | | | |
|---|---|---|---|---|---|---|
| Exper- | Wa- | Ca | gluco- | Swelling | | |
| iment | ter | Hydroxide | mannan | time | | Appearance |
| No. | g | g | g | minutes | pH | confirmation |
| 4 | 100 | 0.30 | 2.5 | 11 | ≧12.5 | Swelling |
| | | | | | | suppression |
| 16 | 100 | 0.25 | 2.5 | 11 | 12.4 | Swelling |
| | | | | | | suppression |
| 17 | 100 | 0.22 | 2.5 | 11 | 12.4 | Swelling |
| | | | | | | suppression |
| 18 | 100 | 0.20 | 2.5 | 11 | 12.3 | Light |
| | | | | | | swelling |

### EMBODIMENT 2

3.3g of Amorphophallus oncophyllus derived konjac-glucomannan is added to a mixed solution of 0.25 g calcium hydroxide in 100 g of water. The mixture was stirred for 10 minutes. 0.55 g of citric acid was added to the denatured glucomannan in which an acetyl group was isolated, removing the swelling suppression, followed by stirring for 5 minutes to confirm swelling. After 45 minutes, the swollen glucomannan is sterilized through heating for 30 minutes. A heat irreversible gel with a 4.5 pH and a consistency of soft konjac gelatin is obtained.

As may be seen by table 1, to obtaining the denatured glucomannan from the Japanese produced konjac-glucomannan obtained by KONJAC, the pH is should exceed 12.4, which results from the use of an amount of calcium hydroxide that is greater than 8.8% of the weight of the konjac-glucomannan. In the case of Amorphophallus oncophyllus derived konjac-glucomannan, it may be seen that the denatured glucomannan is obtained when the pH exceeds 11.7, which results from the use of an amount of calcium hydroxide that is greater than 7.6% of the weight of the konjac-glucomannan. These different results are obtained due to the kind and qualities of the konjac-glucomannan used. For example, as shown Table 1, Experiment 8, a denatured glucomannan cannot be obtained from the Japanese-produced konjac-glucomannan made by KONJAC using only 8% calcium hydroxide, while a denatured glucomannan may be obtainable under such conditions from Amorphophallus oncophyllus derived konjac-glucomannan.

### EMBODIMENT 3

2.5 g of konjac-glucomannan was mixed into a solution containing 0.3 g of calcium hydroxide, and was stirred for 11 minutes. The acetyl group is isolated and swelling is controlled in the denatured glucomannan that settled.

TABLE 2
Experiment on the influence of water
volume to the konjac-glucomannan

| | | | Konjac- | | | |
|---|---|---|---|---|---|---|
| Exper- | Wa- | Ca | gluco- | Swelling | | |
| iment | ter | Hydroxide | mannan | time | | Appearance |
| No. | g | g | g | minutes | pH | confirmation |
| 5 | 100 | 0.3 | 2.5 | 11 | ≧12.5 | Swelling |
| | | | | | | suppression |
| 19 | 75 | 0.3 | 2.5 | 11 | ≧12.4 | Swelling |
| | | | | | | suppression |
| 20 | 50 | 0.3 | 2.5 | 11 | ≧12.5 | Swelling |
| | | | | | | suppression |

### EMBODIMENT 4

2.5 g of konjac-glucomannan was mixed into a solution of 0.3 g of calcium hydroxide in 25 g of water, and stirred for 11 minutes. A denatured glucomannan is obtained in which the acetyl group is isolated and swelling was suppressed

Embodiment 4 and the experiments of Table 2 indicate that denatured glucomannan can be obtained from conditions where the amount of water used is at least as low as 10 times the amount of the konjac-glucomannan by weight.

### EMBODIMENT 5

(Drying of denatured glucomannan and production of gelatinized product) When 5g of konjac-glucomannan is mixed into a solution of 0.6g of calcium hydroxide in 5g of water, the konjac-glucomannan absorbed the solution in several seconds. It is mixed uniformly, and all lumps are squashed, and the resulting product is dried to obtain a denatured glucomannan in powdered form where the acetyl group has been isolated and the swelling is suppressed. 3g of the dried denatured glucomannan is added to 100cc of water and stirred for 12 minutes to that swelling has been suppressed. 0.5g of citric acid is then added to the solution to remove the swelling suppression, and after swelling, the product is packaged. Gelatinization occurs heating for one hour at 80 to 90 deg C., following by heat sterilization for 30 minutes. A heat irreversible gel is thus obtained.

### EMBODIMENT 6

(Producing gelatinized product and food product that used denatured mannan) 2.5 g of konjac-glucomannan is mixed into a solution of 0.3 g of calcium hydroxide in 100 g of water, and is stirred for 11 minutes. The formation of denatured glucomannan is confirmed, in which the acetyl group is isolated and the swelling was suppressed. The required amount of citric acid was added to remove the swelling suppression, and the resulting neutralized glucomannan was swollen in 4-5 minutes, and then packaged. It was heated at 80-90° C. for 45 minutes to obtain a gel.

TABLE 3
Producing gelatinized product using denatured glucomannan

| | Mixed and Stirred in Mixed solution | | | | | | After adding citric acid | | | | After heating | | |
|---|---|---|---|---|---|---|---|---|---|---|---|---|---|
| | (isolated and swelling suppression of Acetyl group) | | | | | | (before heating) | | | | Heating | | |
| Exper- | | Ca | Konjac- | Swelling | | | Citric | Swelling | | | temper- | | Gelatinized |
| iment | Water | Hydroxide | gluco- | time | | Appearance | acid | time | | Appearance | ature | | product |
| No. | g | g | mannan | minutes | pH | confirmation | g | minutes | pH | confirmation | ° C. | pH | confirmation |
| 1 | 100 | 0.30 | 2.5 | 11 | ≧12.5 | Swelling | 0.30 | 60.00 | 12.1 | Granular | 80-90 | 11.6 | Δ |
| | | | | | | suppression | | | | sol | | | |
| 2 | 100 | 0.30 | 2.5 | 11 | ≧12.5 | Swelling | 0.33 | 5.00 | 12.0 | Granular | 80-90 | 11.1 | Δ |
| | | | | | | suppression | | | | sol | | | |
| 3 | 100 | 0.30 | 2.5 | 11 | ≧12.5 | Swelling | 0.35 | 10.00 | 11.8 | Homogenous | 80-90 | 10.5 | ◯ |
| | | | | | | suppression | | | | sol | | | |
| 4 | 100 | 0.30 | 2.5 | 11 | ≧12.5 | Swelling | 0.40 | 5.00 | 11.7 | Homogenous | 80-90 | 9.5 | ◯ |
| | | | | | | suppression | | | | sol | | | |
| 5 | 100 | 0.30 | 2.5 | 11 | ≧12.5 | Swelling | 0.45 | 5.00 | 5.8 | Homogenous | 80-90 | 6.0 | ◯ |
| | | | | | | suppression | | | | sol | | | |
| 6 | 100 | 0.30 | 2.5 | 11 | ≧12.5 | Swelling | 0.50 | 5.00 | 5.3 | Homogenous | 80-90 | 5.4 | ◯ |
| | | | | | | suppression | | | | sol | | | |
| 7 | 100 | 0.30 | 2.5 | 11 | ≧12.5 | Swelling | 0.60 | 4.00 | 4.7 | Homogenous | 80-90 | 4.9 | ◯ |
| | | | | | | suppression | | | | sol | | | |
| 8 | 100 | 0.30 | 2.5 | 11 | ≧12.5 | Swelling | 0.70 | 4.00 | 4.6 | Homogenous | 80-90 | 4.6 | ◯ |
| | | | | | | suppression | | | | sol | | | |
| 9 | 100 | 0.30 | 2.5 | 11 | ≧12.5 | Swelling | 0.80 | 4.00 | 4.3 | Homogenous | 80-90 | 4.4 | ◯ |
| | | | | | | suppression | | | | sol | | | |
| 10 | 100 | 0.30 | 2.5 | 11 | ≧12.5 | Swelling | 0.90 | 4.00 | 4.2 | Homogenous | 80-90 | 4.0 | ◯ |
| | | | | | | suppression | | | | sol | | | |
| 11 | 100 | 0.30 | 2.5 | 11 | ≧12.5 | Swelling | 1.00 | 4.00 | 4.0 | Homogenous | 80-90 | 4.0 | ◯ |
| | | | | | | suppression | | | | sol | | | |
| 12 | 100 | 0.30 | 2.5 | 11 | ≧12.5 | Swelling | 1.30 | 4.00 | 3.7 | Homogenous | 80-90 | 3.6 | ◯ |
| | | | | | | suppression | | | | sol | | | |
| 13 | 100 | 0.30 | 2.5 | 11 | ≧12.5 | Swelling | 1.50 | 4.00 | 3.6 | Homogenous | 80-90 | 3.5 | ◯ |
| | | | | | | suppression | | | | sol | | | |
| 14 | 100 | 0.30 | 2.5 | 11 | ≧12.5 | Swelling | 2.00 | 5.00 | 3.4 | Homogenous | 80-90 | 3.3 | X |
| | | | | | | suppression | | | | sol | | | |
| 15 | 100 | 0.30 | 2.5 | 11 | ≧12.5 | Swelling | 2.50 | 5.00 | 3.2 | Homogenous | 80-90 | 3.1 | X |
| | | | | | | suppression | | | | sol | | | |

◯ Gelatin,
Δ brittle/granular solid,
X solid like

### EMBODIMENT 7

(Gelatinized product of denatured glucomannan using raw konjac corm) 50 g of raw konjac corm is crushed in a blender in 1000 cc of water for 1 minute, with the crushed konjac allowed to settle. Clean water is removed from, leaving the crushed konjac in only 250 cc of water. 0.6 g of calcium hydroxide is stirred well. After 5 minutes, swelling suppression is confirmed at pH>=12.5. After 5 minutes, 0.8 g of citric acid is added, and swelling results in 5 minutes. A swollen solid of pH 9.9 is obtained. After 1 hour, the swollen solid is sterilized by heating at 80-90° C. (176-194° F.) for 40 minutes. A heat-irreversible konjac gel having a pH of 10.3 is obtained, without any of the characteristic konjac odor, hard taste, or bitterness.

### EMBODIMENT 8

(Dehydration and drying of denatured glucomannan and gelatinized product formed therefrom) 12 g of konjac-glucomannan is added to a solution of 1.8 g of calcium hydroxide in 400 cc of water. After stirring for 11 minutes, swelling suppression is confirmed, and the solution is filtered with cloth, resulting in 149 g of moist denatured glucomannan. 75 g of the moist denatured glucomannan is dehydrated lightly and frozen. The remaining 74 g is stored in the refrigerator for 3 days. 100 g of water is added to 73 g of the refrigerated denatured glucomannan and then stirred. The swelling suppression is confirmed. 1.2 g of citric acid is then added, and after 2 minutes, a swollen solid is obtained, confirming removal of swelling suppression. After 1 hour, the swollen solid it is sterilized in boiling water at 80-90° C. (176-194° F.) for 40 minutes, obtaining a heat-irreversible—gel with pH 4.5. 100 g of water is added to the denatured glucomannan refrigerated for 3 days after defrosting. Following mixing, swelling suppression is confirmed. 1.2 g of citric acid is added after 10 minutes and stirred. After 5 minutes, a swollen solid is obtained, confirming removal of swelling suppression. After 1 hour, it undergoes sterilization in boiling water at 80-90° C. (176-194° F.) for 40 minutes and a heat-irreversible gel with pH 4.5 is obtained.

As shown in Table 3, when the amount of citric acid added to the denatured glucomannan is between 3 to 13 parts by weight to 3 parts by weight of the calcium hydroxide used to generate the denatured glucomannan, swelling suppression is removed, and a swollen solid with a pH range from 12.1 to 3.6 is obtained. Gels with a pH range from 12.1 to 3.6 may be obtained therefrom by heating, and viscoelastic heat-irreversible gels with pH 10.5 to 3.6 may also be obtained.

### EMBODIMENT 9

(Using acetic acid to remove swelling suppression) 2.5 g of finely powdered konjac-glucomannan is added to a solution of 0.25 g of calcinated shell calcium in 100 g of water and stirred for 5 minutes. Formation of a denatured glucomannan in which the acetyl group was isolated and swelling was suppressed is confirmed. 1 g of acetic acid and 0.2 g of glycine are added to remove swelling suppression. After swelling for 2 minutes, the resulting solid is determined to have a pH of 11.9. It is then packaged, and after 45 minutes it is heated with boiling water at 80-90° C. (176-194° F.) for 30 minutes, and a heat-irreversible gel is obtained. The pH level of the konjac-like gel is 4.5. There was no konjac odor, but there was an acidic taste and smell.

### EMBODIMENT 10

(Using food product to remove swelling suppression) 5 g of konjac-glucomannan is added to a solution of 1 g of calcium hydroxide in 150 cc of water, and is stirred for 11 minutes. Swelling suppression is confirmed. 60 cc of grape flavored Calpis beverage (Calpis Co., Ltd), 5 g of sugar and 1.2 g of citric acid are mixed together and then added to the denatured glucomannan, and stirred for 4 minutes. After 60 minutes, the resulting solid is sterilized in boiling water at 80-90° C. (176-194° F.) for 60 minutes. A tasty, viscous heat irreversible gel with a pH of 4.7 is obtained.

### EMBODIMENT 11

(Using food product in removing swelling suppression) 1 g of calcium hydroxide is mixed with 150 cc of water, adding 5 g of konjac-glucomannan into it and stirred for 12 minutes. The swelling suppression of konjac-glucomannan is confirmed and it is swollen if 60 g of canned tangerine (Dole Co., Ltd), 5 g of sugar and 1.2 g of citric acid is added and stirred for 4 minutes. 60 minutes after putting into bag, it is sterilized in boiling water at 80-90° C. (176-194° F.) for 60 minutes, obtaining a refreshing heat irreversible gel with viscosity of pH 4.4.

### EMBODIMENT 12

(Using food product in removing swelling suppression) 10 g of konjac-glucomannan, 30 g of Okonomiyaki flour (Nisshin Seifun Group) and 2 g of calcium hydroxide are added to 300 cc of hot water at 24° C. (75° F.), and stirred for 10 minutes. 2.4 g of citric acid is added and mixed, and left in for 10 minutes. 230 g cabbage, 50 g chicken, 20 g tempura scraps, 5 g dried bonito, 3 g red pickled ginger and 1 egg weighing 62 g are mixed as ingredients. The gelatinized lump is baked in a frying pan for 30 minutes. Compared to the usual Okonomiyaki, it is confirmed that the resulting Okonomiyaki reduces the caloric intake from Okonomiyaki flour by 70%, and the konjac does not affect the odor, flavor, or texture of the food product from the usual Okonomyaki, whether freshly baked or after 30 days, even if frozen and heated with a microwave.

(Using food product in removing swelling suppression) 5 g konjac-glucomannan and 1 g calcium hydroxide is added to 150 cc of hot water in 24° C. (75° F.), stirred for 11 minutes, whereupon the swelling suppressing of konjac-glucomannan is confirmed. 1.2 g of citric acid and 60 g of Chinese mustard pickle (Fujicco Co., Ltd.) is added, and swelling occurs. The swollen solid is placed into a bag and sterilized in boiling water at 80-90° C. (176-194° F.) for 60 minutes, obtaining a heat irreversible gel with a pH of 8.4. It is confirmed that the konjac does not affect the odor, flavor, or texture of the food product.

1-4. (canceled)

5. A method of suppressing swelling of glucomannan, the method comprising isolating the acetyl groups of the glucomannan via treatment with a high alkali solution, the high alkali solution having a pH of 11.7 or higher.

6. The method of claim 5, wherein the high alkali solution has a pH of 12.4 or higher.

7. The method of claim 5, wherein the high alkali solution is formed via the addition of calcium hydroxide.

8. The method of claim 5, wherein the high alkali solution comprises ethanol.

9. A method of producing a heat-irreversible gelatinized glucomannan food product, the method comprising:
providing a denatured glucomannan formed via the isolation of the acetyl groups of glucomannan via treatment with a high alkali solution having a pH of 11.7 or higher;
adding a pH-lowering ingredient to the denatured glucomannan to form a neutralized glucomannan; and
heating the neutralized glucomannan to induce gelatinization.

10. The method of claim 9, wherein the high alkali solution has a pH of 12.4 or higher.

11. The method of claim 9, wherein the high alkali solution is formed via the addition of calcium hydroxide.

12. The method of claim 9, wherein the high alkali solution comprises ethanol.

13. The method of claim 9, wherein the pH-lowering ingredient comprises citric acid.

14. The method of claim 9, wherein the pH-lowering ingredient comprises glucono delta-lactone.

15. A denatured glucomannan, the denatured glucomannan comprising glucomannan wherein the acetyl groups of the glucomannan has been isolated via treatment with a high alkali solution, the high alkali solution having a pH of 11.7 of higher.

16. The denatured glucomannan of claim 15, wherein the high alkali solution has a pH of 12.4 or higher.

17. The denatured glucomannan of claim 15, wherein the high alkali solution is formed via the addition of calcium hydroxide.

18. The denatured glucomannan of claim 15, wherein the high alkali solution comprises ethanol.

19. The denatured glucomannan of claim 15, wherein the denatured glucomannan has been preserved via dehydration.

20. The denatured glucomannan of claim 15, wherein the denatured glucomannan has been preserved via freezing.

21. The denatured glucomannan of claim 15, wherein the denatured glucomannan has been sterilized.

22. The denatured glucomannan of claim 15, wherein the glucomannan is derived from a species of the family Araceae.

23. The denatured glucomannan of claim 22, wherein the glucomannan is derived from Amorphopallus konjac.

24. The denatured glucomannan of claim 22, wherein the glucomannan is derived from Amorphophallus oncophyllus.
